(19) United States
(12) Patent Application Publication
(10) Pub. No.: US 2026/0324665 A1
(43) Pub. Date: Oct. 22, 2026

(54) GRAIN DRYING, CONDITIONING, AND TRACKING SYSTEM WITH AI MODELS USED IN CONTROLS FOR DYNAMIC AIRFLOW MANAGEMENT

(71) Applicant: SHIVVERS MANUFACTURING, INC., Corydon, IA (US)

(72) Inventor: Dillon G. Hurd, Ames, IA (US)

(21) Appl. No.: 19/650,998

(22) Filed: Apr. 17, 2026

Related U.S. Application Data
(60) Provisional application No. 63/790,806, filed on Apr. 18, 2025.

(51) Int. Cl. A23B 9/08; A23B 9/02; F26B 17/12

(52) U.S. Cl. CPC A23B 9/08; A23B 9/025; F26B 17/122; F26B 2200/06

(57) ABSTRACT

A grain drying system having a wet-holding pre-drying stage, a main drying stage, and a dryeration stage. The wet-holding pre-drying stage has a wet holding bin that receives harvest grain and at least one sensor disposed within the wet holding bin. The harvested grain within the wet-holding bin is broken into digital lots and the at least one sensor provides a profile of the digital lots that is transmitted to a control system that builds a model used in a feedforward control loop. The control system creates a prescription for the digital lot by setting parameters using a machine-learning model. Using the created prescription, harvested grain in the wet holding bin is dried using an aeration system. The main drying system has one or more drying mechanisms. One or more of the drying mechanisms is a mixed flow dryer having at least one grain column adjacent to and in communication with a plenum having a fan and a heater, and an unloading system. A plurality of sensors are positioned throughout the mixed-flow dryer, plenum, and unloading system. The dryeration stage uses a plurality of fans and containers that receive harvested grain from the main drying stage. A plurality of sensors are positioned in the containers. The fans push air into the containers and the plurality of sensors transmit information to the control system that adjusts air quality and quantity that is pushed into the containers.

### CROSS REFERENCE TO RELATED APPLICATION

This application claims the benefit of U.S. Provisional Patent Application Ser. No. 63/790,806 filed Apr. 18, 2025, the contents of this application is hereby incorporated by reference in its entirety.

### BACKGROUND OF THE INVENTION

Efficient grain drying is a critical step in post-harvest processing to ensure grain quality, prevent spoilage, and maximize market value. Traditional grain drying methods, including batch drying, cross-flow drying, and continuous-flow drying, have been widely used for decades. However, these systems have inherent inefficiencies and limitations that negatively impact drying performance, energy consumption, and grain quality.

One significant challenge in conventional drying systems is non-uniform drying. Many existing systems apply a single drying profile to all grains regardless of their initial moisture content, temperature, or other variables. This often leads to over-drying or under-drying, which can cause grain cracking, shrinkage, and loss of marketable weight. Additionally, uneven drying results in increased energy consumption as operators struggle to optimize drying conditions dynamically.

Another major issue is the lack of real-time monitoring and adaptive control. Most traditional drying systems operate on fixed parameters, requiring manual adjustments that depend on the operator's experience. This not only introduces inefficiencies but also increases the risk of human error. Without continuous real-time feedback, changes in ambient air conditions, grain temperature, grain moisture levels, grain quality, or system performance can go unnoticed, leading to excessive energy waste and suboptimal drying results.

Additionally, existing grain drying methods often suffer from inconsistent integration with pre-drying and post-drying stages, such as wet holding, dryeration, and aeration. Many systems do not account for the grain's condition before entering the dryer or how it will behave after drying. This results in inefficiencies in managing drying capacity, increased drying time, and reduced grain throughput. Without an intelligent system that adjusts drying conditions dynamically, operators face bottlenecks in grain processing, especially during peak harvest periods when drying facilities operate at maximum capacity.

Furthermore, high energy consumption and operational costs are persistent concerns. Traditional grain drying methods rely on steady-state heating and airflow without optimization, leading to excessive fuel and electricity use. Given fluctuating energy costs, inefficient grain drying can significantly impact the profitability of farming and grain processing operations.

In response to these challenges, there is a need for an intelligent, adaptive grain drying system that integrates tracking, real-time sensor data, predictive machine-learning models, and dynamic airflow control to optimize drying performance. Such a system should:
1. Precise air flow control using mechanical air flow restriction and/or controlling the depth of the grain.
2. Enhance drying uniformity by tracking and continuously monitoring grain conditions and adjusting drying parameters accordingly.
3. Reduce energy consumption through predictive control of airflow, temperature, and residence time.
4. Improve grain quality and marketability by minimizing over-drying, cracking, and spoilage.
5. Seamlessly integrate wet holding, drying, and dryeration to optimize throughput and efficiency.
6. Leverage advanced data analytics and machine learning to provide automated, self-adjusting drying processes that improve over time.

The present invention addresses these needs by introducing an advanced grain drying system that incorporates air flow control, real-time sensor monitoring, AI-driven optimization, and dynamically controlled drying conditions to revolutionize the efficiency, reliability, and profitability of grain drying operations.

These and other aspects, features, and advantages of the invention will become apparent from the specification and claims.

### SUMMARY OF THE INVENTION

A grain drying system having a wet-holding pre-drying stage, a main drying stage, and a dryeration stage. The wet-holding pre-drying stage had a wet holding bin that receives harvest grain and at least one sensor disposed within the wet holding bin. The harvested grain within the wet-holding bin is broken into digital lots and the at least one sensor provides a profile of the digital lots that is transmitted to a control system that builds a model used in a feedforward control loop.

The control system creates a prescription for the digital lot by setting parameters using a machine-learning model. Using the created prescription, harvested grain in the wet holding bin is dried using an aeration system.

The digital lots can be enhanced by dropping a radio frequency ID into the harvested grain. Alternatively, the digital lots are created by using inventory management tools from the control system.

The main drying system has one or more drying mechanisms. One or more of the drying mechanisms is a mixed-flow dryer having at least one grain column adjacent to and in communication with a plenum having a fan and a heater, and an unloading system. A plurality of sensors are positioned throughout the mixed-flow dryer, plenum, and unloading system.

The at least one grain column is formed by an inner wall, an outer wall and a pair of side walls with a plurality of input ducts, output ducts and exhaust ducts that are arranged in vertical rows within the at least one grain column. The plurality of layers are created by a rectangular section the at least one grain column adjacent the input ducts and output ducts.

Air flow from the plenum is supplied to the plurality of layers independently and continuously by selectively adjusting the area of openings of the input and output ducts. The area of the openings of the input and output ducts are adjusted using a flow restrictor plate positioned adjacent the air ducts that extends horizontally through the at least one grain column.

The main drying stage also has a double-pass cooling stage where at least one diverter plate sends a variable amount of cool air to the outer duct and through at least one grain column and into the plenum either before or after exposure to the heater.

The control system uses information from the wet-holding stage to estimate conditions of the harvested grain as it enters the main drying stage to create prescriptions for the harvested grain in the main drying stage. Then, based on information transmitted from the plurality of sensors positioned throughout the mixed-flow dryer, plenum and unload system the control system adjusts air conditions and flow rates throughout the main drying stage.

Alternatively, the dryer mechanism is a counterflow with a bed adjustment, having a container where harvested grain is pulled off the bottom of the container. The harvested grain is spread evenly across the top of the grain bed using a spreader with a plurality of sensors that transmit information about the harvested grain to the control system. A sweep auger having a plurality of teeth tilted forward of the sweep auger is embedded in the harvested grain to pull the harvested grain toward the top of the grain bed. The sweep auger also has an end shield attached to the outer end.

The dryeration stage uses a plurality of fans and containers that receive harvested grain from the main drying stage. A plurality of sensors are positioned in the containers. The fans push air into the containers and the plurality of sensors transmit information to the control system that adjusts air quality and quantity that is pushed into the containers. The control system uses data from the main drying stage to estimate the condition of the harvested grain when received in the containers and creates prescriptions for the harvested grain in order to reach a desired final temperature and moisture content. The control system adjusts air condition and flow rates in one or more containers based on predicted conditions from the prescription of the main drying stage.

### BRIEF DESCRIPTION OF THE DRAWINGS

FIG. 1 is a schematic view of a grain drying system;

FIG. 2 is a schematic view of a wet holding stage of a grain drying system;

FIG. 3 is a schematic view of a main drying stage of a grain drying system;

FIG. 4 is a schematic view of a grain drying mechanism;

FIG. 5 is a schematic view of a dryeration stage of a grain drying system;

FIG. 6 is a perspective view of a counterflow drying mechanism;

FIG. 7 is a perspective view of a counterflow drying mechanism;

FIG. 8 is a perspective view of a counterflow drying mechanism;

FIG. 9 is a cross-sectional view of a mixed-flow drying mechanism;

FIG. 10 is a partial perspective view of a mixed-flow drying mechanism;

FIG. 11 is a partial perspective view of a mixed-flow drying mechanism;

FIG. 12 is a partial perspective view of a mixed-flow drying mechanism;

FIG. 13 is a flow diagram of a dryeration stage of a grain drying system; and

FIG. 14 is a cross-sectional view of a grain drying mechanism for a grain drying system.

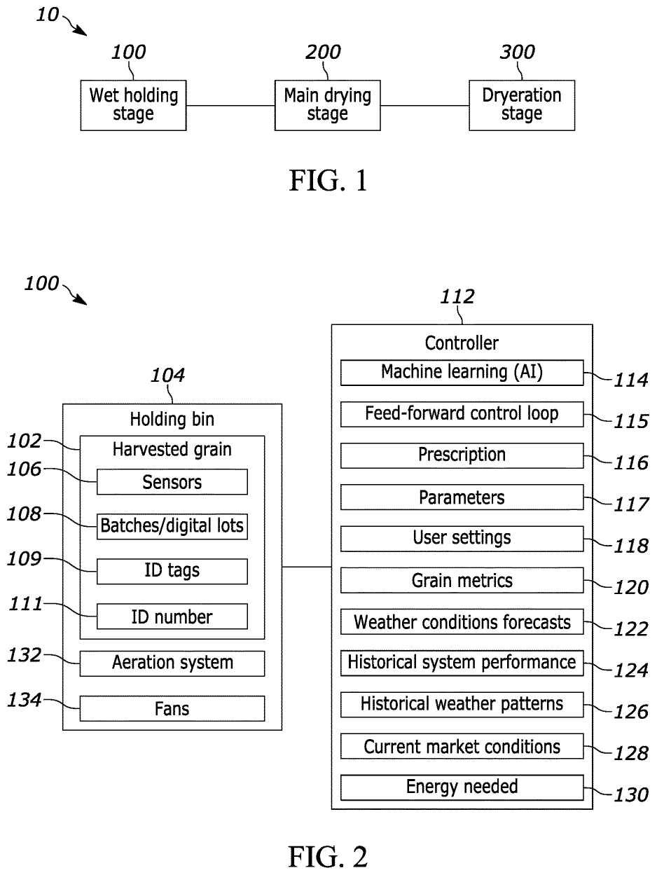

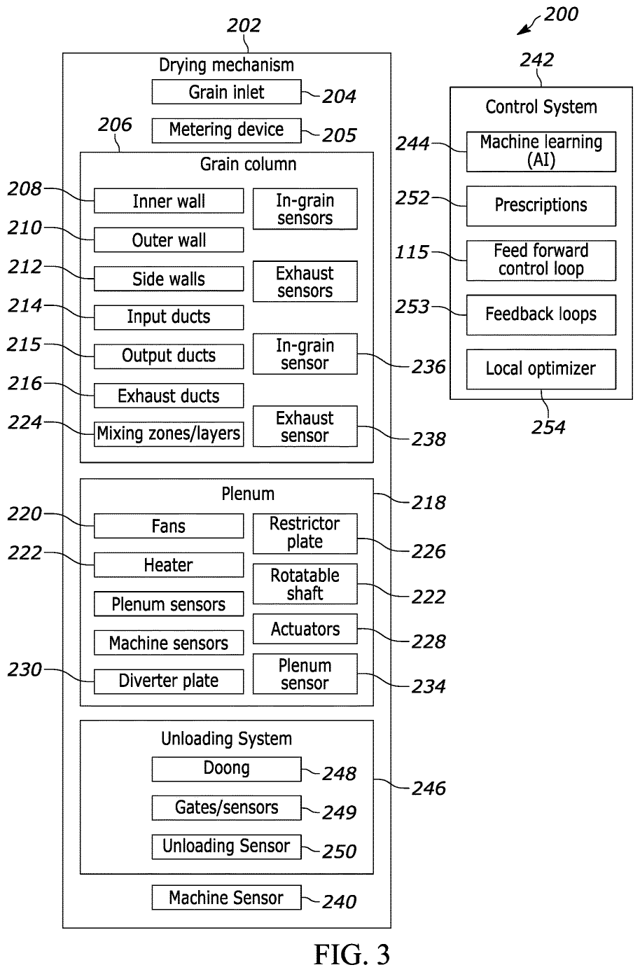

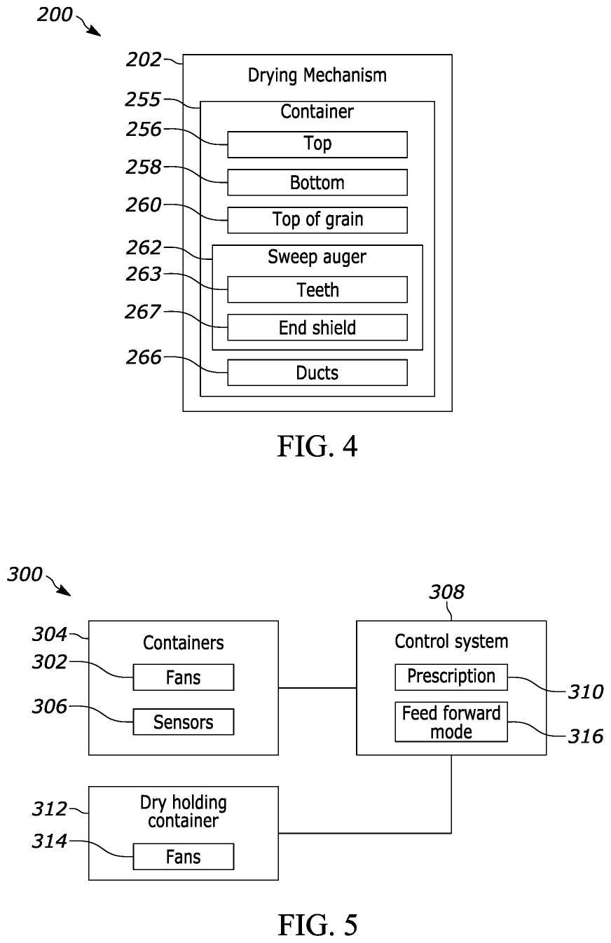

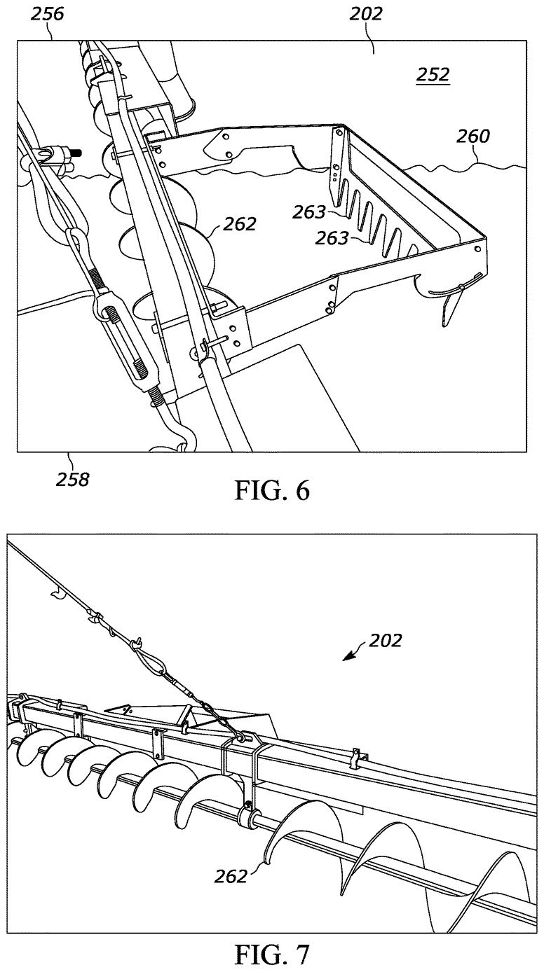

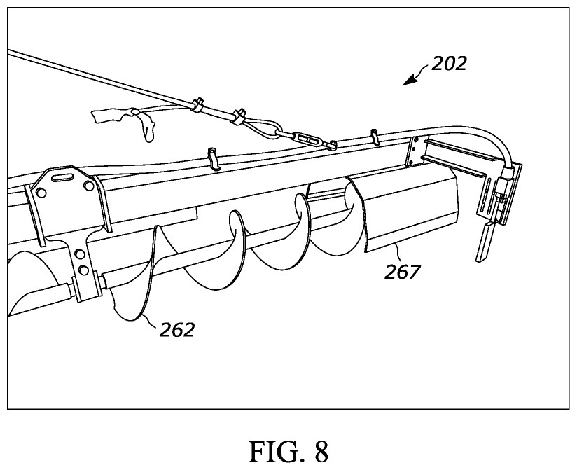

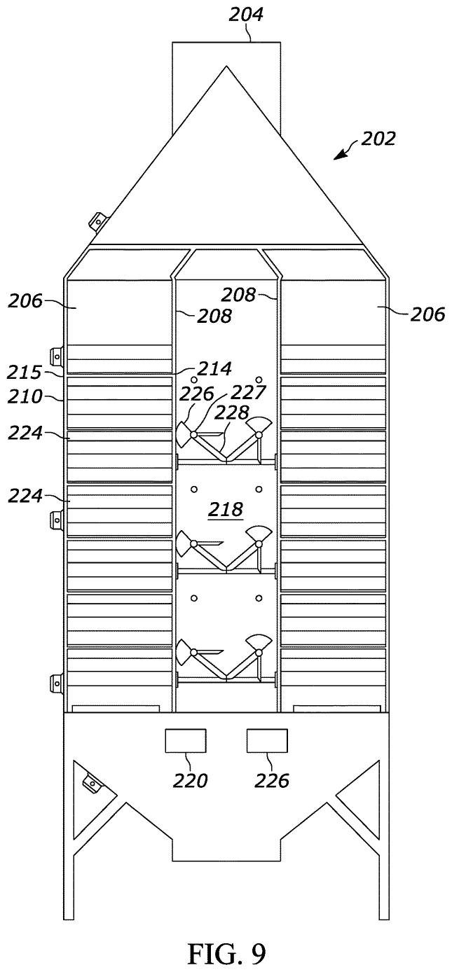

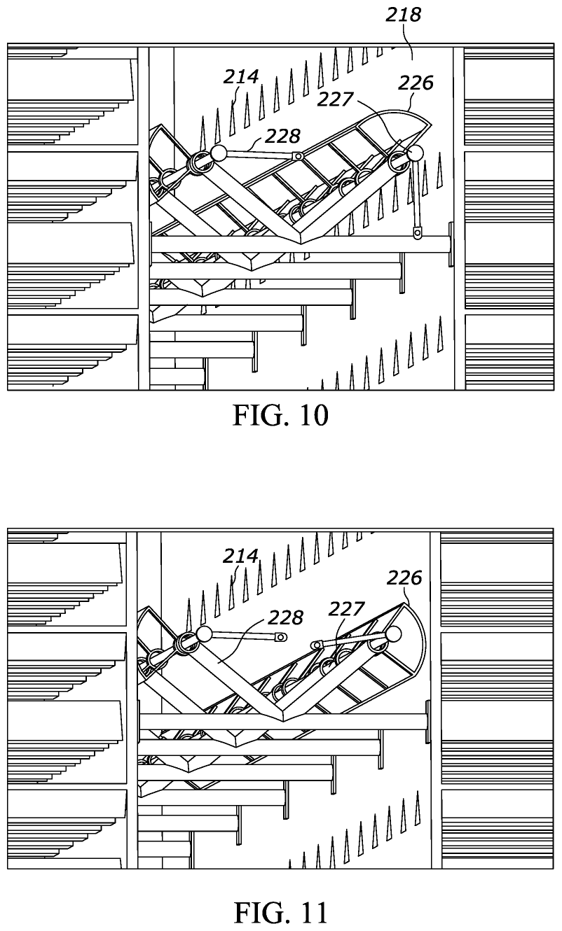

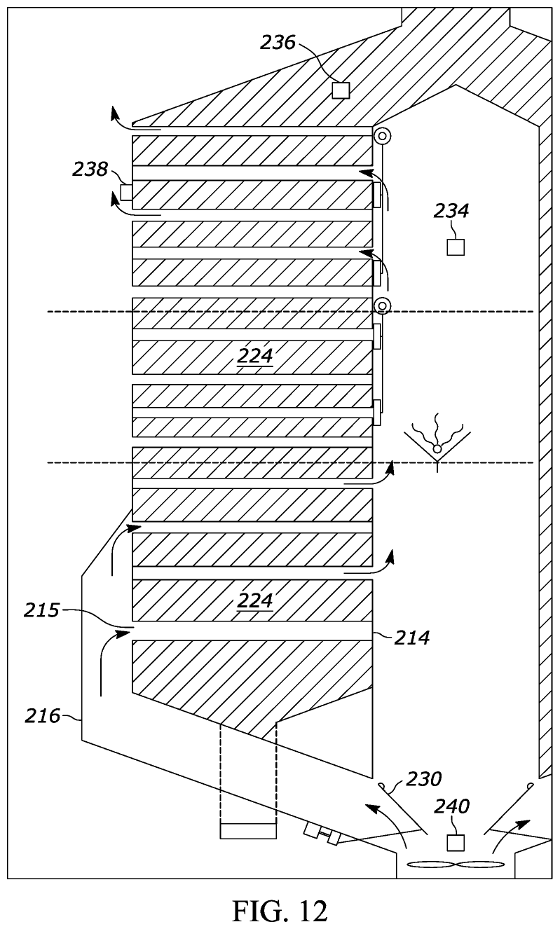

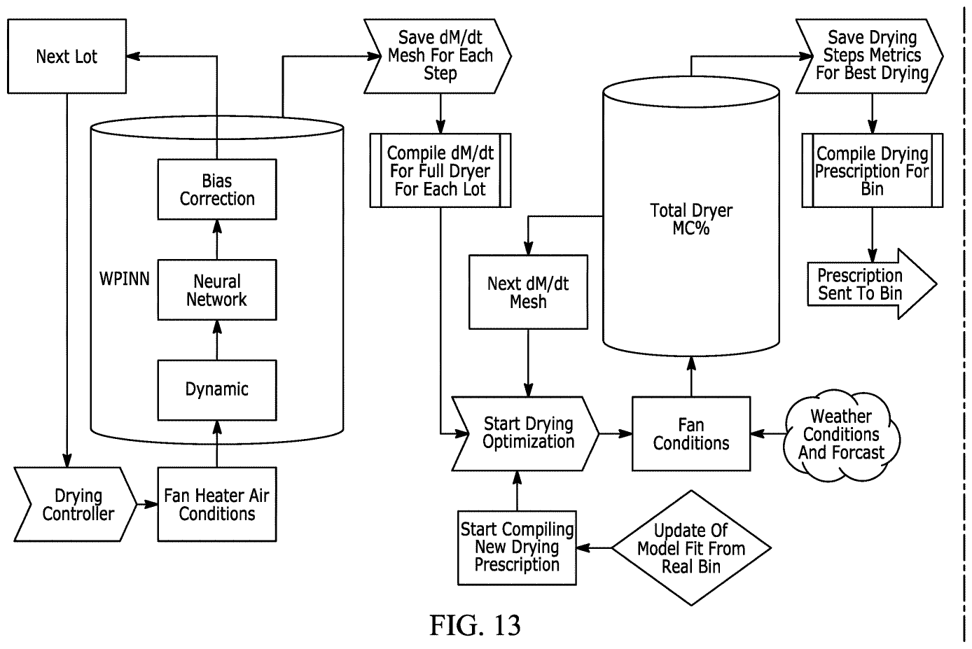

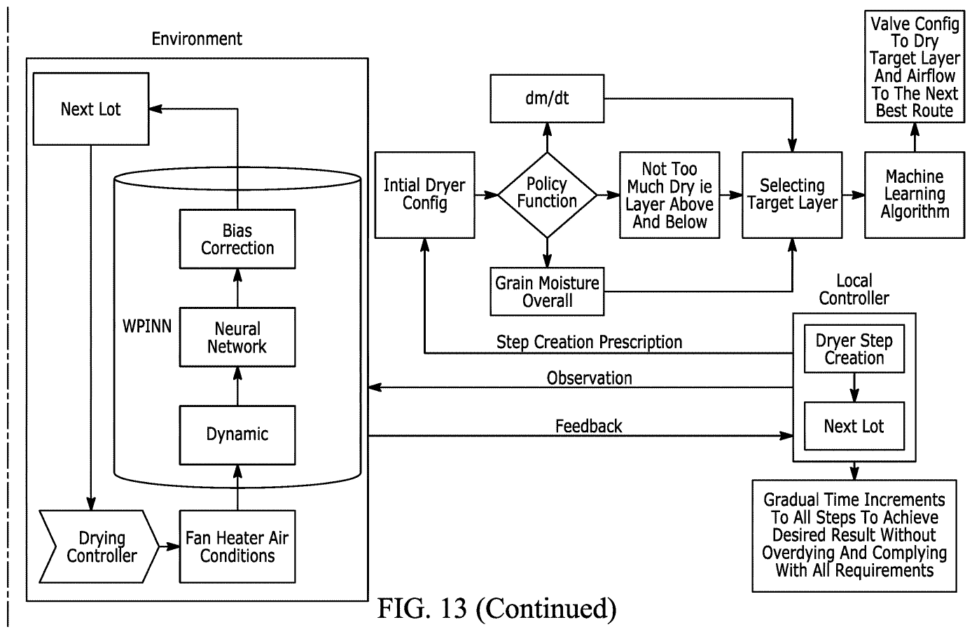

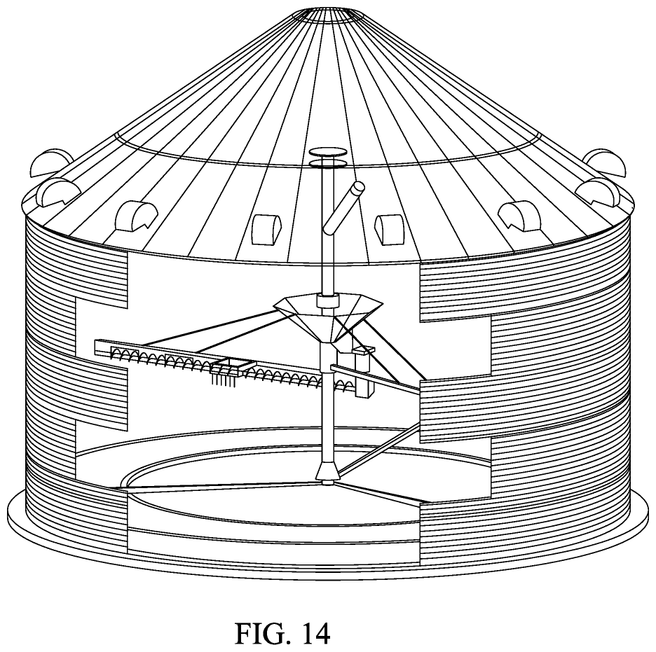

### DETAILED DESCRIPTION

Referring to the figures a drying system 10 includes three stages—a wet holding stage with an option for pre-drying 100, a main drying stage 200, and a dryeration or aeration cooling and conditioning stage 300.

### 1. Wet Holding and Pre-Drying

The wet-holding pre-drying stage 100 involves the temporary storage of high-moisture grain before the grain enters the drying system. The step is crucial in modern grain drying operations, especially when handling large volumes of freshly harvested grain. The purpose of wet holding is to manage workflow efficiency, prevent harvest bottlenecks, and maintain grain quality before drying.

In the wet holding and pre-drying stage, harvested grain 102 is loaded into a wet holding bin 104. Often, after being harvested, grain has a moisture content that is higher than what is safe for long-term storage and instead of going directly into a drying, it is placed in the wet holding bin 104 to await drying.

Disposed within the wet holding bin 104 are a plurality of sensors 106. The sensors 106 are of any type and may include but are not limited to sensors that detect in-grain temperature, relative humidity, capacitance, visual, and electromagnetic (EM) absorption.

When the harvested grain 102 enters the bin site, normally, the wet holding bin 104, is broken into batches or digital lots 108 that are used to identify the grain as it moves through the rest of the process. The grain is broken into lots of 108 in at least two different ways, depending on the requirements of the crop. The first is for high-value crops that need to be tracked with high resolution and need to be identity preserved. This lot tracking can be done by dropping active or inactive radio frequency ID tags 109 or some other device into the grain as it is harvested by a combine or as the grain is being put into the wet holding bin. These trackers or tags 109 also have the ability to take readings like temperature, humidity, acceleration, and position while in the grain 102 and store that data to be retrieved or uploaded upon recovery or when in range of a receiver. The IDs of the tags 109 are then put onto the blockchain or similar secure ledger 107 along with the other data related to the crop, like harvest date, location, grain type variety, and moisture content. These tags 109 stay in the grain as they move from the field to their final use. At final use, the tags 109 are removed using rock catch screens or something similar or using magnets to draw them out of the grain 102. When recovered, the data is recovered from the tags 109 if it has not already been uploaded. The frequency of the tags 109 in a large volume of grain 102 can also provide the end buyer with information on whether the grain 102 has been blended. If tags 109 were placed at a rate of 1 per 1,000 lb but during tag recovery there are only tags 109 for every 1,500 lb, the end buyer would know grain was added to the lot. The tags 109 can be read by transmitters/receivers that can be placed throughout the bin site or even through the larger supply chain. For example, ID tag readers can be placed in locations like bridges or rail terminals, where grain is being moved, whether in a truck, train car, or another vehicle; the tags can then be pinged, and their location can be tracked in route. This allows high-resolution tracking of the grain lots. Whenever a tag 109 is read the information can be added to the ledger 107.

If the grain 102 does not need this level of tracking the lots 108 can be created by using the inventory management tools in the bin site controller 112. As the first bin is being filled, the computer takes readings of the amount of grain in the bin 104, and for every 1,000 lbs of grain that is added, the computer gives it an ID number 111 on the ledger 112 and adds the harvest date, location, grain type variety, and moisture content to the digital lot. By knowing the amount of grain that is being moved from one bin to the next, the computer 112 can keep an inventory of the grain 102 as it moves. This may be enough data for many crops where the grain lots 108 are managed as a total mass balance. An example is a farmer having a million bushels of corn with a carbon intensity score of X and that corn is stored on a bin site with two million bushels; the carbon intensity (CI) is applied to all bushels as a mass balance of the CI and all the bushels sold from this site. The digital inventory tracking of lots would be effective in giving the farmers clear records of the grain and its characteristics. A ledger 107 is used to track harvesting information 109 about the batch 108 such as the combine or other farm equipment used, the harvest location, or the like. Sensors 106 are positioned within each bin 104 to provide a profile 110 of the batch 108 that is transmitted to a control system 112 that includes a machine-learning (AI) model 114. The machine-learning model 114 may live on a local computer or cloud.

The transmitted profile 110 of each batch 108 contains information collected from the sensors 106 about the grain 102. Once received by the control system 112 the transmitted profile begins a building a model to be used by the feedforward control loop 115 by quantifying input of the grain 102 in the batch 108. Using the machine-learning model 114, the control system 112 creates a prescription 116 for the batch 108 by setting parameters 117 to be met by the drying system 10 throughout the drying process based on desired results. To create the prescription 116 the machine-learning model 114 uses, in addition to the transmitted profile 110, various items such as user settings 118, grain metrics 120, current weather conditions and forecasts 122, historical system performance 124, and historical weather patterns 126. In addition, current market conditions 128 of the grain 102 and energy needed 130 to obtain the highest profit may be considered as well.

Based on the determined prescription 116, the grain 102 in the wet holding bin 104 is dried with an aeration system 132 using heat and air or just air alone. The aeration system 132 is of any type. In one example the aeration system 132 is a variable airflow system using a variable frequency drive to control the fans 134. Alternatively, the aeration system is the DRI-Stack® system manufactured by Shivvers Technology and Innovation Group and disclosed in U.S. Pat. Nos. 11,820,588 and 12,066,799 incorporated herein in its entirety.

When desired parameters 117 are met as set forth in the prescription 116 for the batch 108, the batch 108 is transferred from the wet holding bin 104 to begin the main drying stage 200.

### 2. Main Drying Stage

The main drying stage 200 includes the use of one or more drying mechanisms 202 used to control air conditions within the drying stage 200 and the speed at which the grain travels through the drying stage 200. The air condition is enhanced by dynamically and variably controlling the temperature and or the mass flow rate of air through the drying mechanism 202.

In one example, the drying mechanism 202 is a mixed-flow dryer. Mixed-flow dryers are known in the art and are part of an agricultural grain drying system that combines elements of both cross-flow and concurrent-flow drying to enhance efficiency, reduce heat damage, and ensure uniform moisture removal.

A mixed-flow dryer includes a grain inlet or loading hopper 204 which is where wet grain is introduced into the dryer 202. The grain device may have a metering device 20 to control the flow of incoming grain 102 and sensors to reading the grain condition. The grain inlet 204 is in communication with a pair of grain columns 206 that are formed by an inner wall 208, an outer wall 210 and a pair of side walls 212. A plurality of input ducts 214, output 215, and exhaust ducts 216 are arranged in vertical rows on the walls 208, 210, and 212 of the columns 206. Typically, the air ducts 214, 215, and 216 have alternating rows to facilitate mixing and uniform moisture removal. The arrangement of the ducts also provides air flow from multiple directions including cross-flow, counterflow, and concurrent flow to ensure even drying.

Disposed between a pair of drying columns 206 is a plenum 218 that is used to distribute heated air into the drying columns 206. One or more fans 220 are provided in the plenum 218 to force air movement through the dryer 202. Any heat device such as a heater 222, burner, or the like is used to provide heated air into the plenum 218.

Within the grain columns 206 are a plurality of mixing zones or layers 224 that are created by a rectangular section in the columns 206 adjacent the ducts 214 and 215 to ensure that the grain is exposed to air from the plenum 218 from multiple angles. Air flow to each layer 224 is controlled independently from other layers 224 to provide variable air flow. To achieve independent and variable air flow different mechanical methods are available. In one example the area of the openings to the input ducts 214 and output ducts 215 are varied. In so doing, the mass flow rate of the air from the plenum 218 into the grain 102 in the grain column 206 is adjusted and varied.

Adjusting the area of the air ducts 214 and 215 is done selectively and continuously. In one example shown a flow restrictor plate 226 is positioned adjacent the air ducts 214 and 215 and extends horizontally through the grain columns 206. The flow restrictor plate 226 is mounted to a rotatable shaft 227 that is driven by a prime mover (not shown) having discrete states like pneumatic cylinders or other types of actuators 228. For continuous control, the prime mover is an electric motor (e.g., AC, DC, stepper, servo), internal combustion engine (e.g. gasoline, diesel), hydraulic or pneumatic motors, turbine-based motors (e.g., steam, gas), or other types (e.g., piezoelectric or magnetic motors).

The quality and quantity of the air that flows from the plenum 218 into the grain columns 206 is also controlled. The heater 222 increases the temperature of the air that flows directly to the plenum 128 and subsequently through the input ducts 214 into the grain columns 106, through the grain 102, and through the exhaust ducts 216.

Additionally or alternatively, a double-pass cooling stage is utilized. In the double-pass cooling stage, air from the fan is diverted using a diverter plate 230 to send some of the cool air to the outer ducts 215 instead of directly to the plenum 218. The diverted air flows through the outside duct 215 into the grain column 206 and through the grain 102 and is then exhausted into the plenum 218. Air quality in the plenum 218 is adjusted by the double-pass cooling stage as the diverted air returns to the plenum 218 in a different condition than the heated ambient air that flows directly from the heater 222 due to the diverted air's passage through the grain in the double-pass cooling stage. The temperature and humidity of the diverted air will differ based on the temperature and moisture conditions of the grain it passes through. The diverted air can also be exhausted to the plenum before or after the primary heating stage is present. Air quantity is controlled by increasing or decreasing fan speed and the energy used by the fans and heater 222 are adjusted to optimize profitability.

A plurality of sensors 232 are used throughout the mixed-flow dryer 202 and include plenum sensors 234, in-grain sensors 236, exhaust sensors 238 and machine sensors 240. The plenum sensors 234 are of any type and include sensors to detect temperature, humidity, pressure, air flow rate, volatile gases, vision, and thermal.

In-grain sensors 236 are of any type used to detect temperature, humidity, pressure, grain and air flow rate, volatile gases, electromagnetic absorption, and capacitance. Exhaust sensors 238 include any type that detect temperature, humidity, pressure, air flow rate, volatile gases, vision, and thermal. Machine sensors 240 are of any type include those that detect ambient temperature, ambient humidity, prime mover temperature, fan motor temperature, fan motor amperage, vibration, volatile gases, gas pressure, gas flow rate, flame state, vision, and thermal. As part of the machine are the grain sensors at the input and output of the dryer 202 to detect temperature, humidity, moisture, capacitance, electromagnetic absorption, and vision.

Sensors 232 transmit detected information to a control system 242 that includes a machine-learning (AI) model 244. The machine-learning model 244 may live on a local computer or cloud. The control system can use the prescriptions 116 developed in the wet holding stage if present.

The dryer 202 also has an unloading system 246 that includes doors 248 at the bottom of the dryer 202, adjustable metering gates or augers 249 used to regulate the discharge of dried grain. The unloading system 246 can also contain sensors 250 to ensure optimal residence time and consistent moisture content.

The machine-learning model 244 of the dryer 202 is expanded or contracted based on the number of inputs and manipulated variables that are transmitted and available during the main drying stage 200. In one example, in operation, the control system 242 uses information from the wet holding stage 100 to estimate conditions of the grain 102 as it enters the dryer 202 and begins making new prescriptions 252 for the grain 102 in the main drying stage 200.

Based on initial conditions as the grain 102 enters the dryer 202, the control system 242 adjusts the air conditions and flow rates throughout the main drying stage 202 based on a prescription 252 or feed-forward model. As the grain 102 moves through the dryer 202, the control system 242 adjusts the air condition and flow rate based on information transmitted from the sensors 232 of the entire dryer 202.

In one example, the feed-forward model 115 predicts the condition of the temperature and humidity sensors 236 in the grain at a certain stage within the dryer 202, and when the grain of a certain lot gets to that stage, the difference between the predicted and sensed (measured) conditions is calculated. The difference or error is used by the feed-back loop 253 and a local optimizer 254 can be used to adjust the feed-forward model 115 in real-time. Adjustment is made to the dryer based on the adjusted feed-forward model 115 and changes are made throughout the dryer 202. For example, the flow restrictor plates 226 are adjusted to change the flow area of the ducts 214 and 215 to permit air flow that adjusts the grain variables back to the target for the current and next stage 200 and 300. In other words, one does not have to wait until the grain is discharged from the dryer 202 to determine what changes need to be made but rather the dryer is adjusting the air volume and condition each lot of grain sees as it passes through the dryer.

The machine learning model 244 can be comprised of multiple model structures, including, but not limited to, theoretical models, models based on the physics of the system, like mass and energy balance. Empirical models like artificial neural networks (ANN), which are models that have no information about the physical properties of the model's system. Semi-empirical models like Weiner Models, which use equations that have physical constraints but are not based directly on the physics of the modeled system. Additional one or all of these models can be combined to create a hybrid model that uses a semi-empirical model (Weiner) and is followed by an empirical model (ANN) to create a physical AI model like a Weiner Physically Informed Neural Network model (W-PINN). The hybrid models can be effective as they provide a strong general model (Weiner) that can be used across dryers with a specific model (ANN) that can capture the specifics of the individual system. This structure can improve the machine-learning model 244 functionality as it can allow for quick re-training of the ANN with a local optimizer 252 without requiring a full feed-forward model 115 retrain to adapt to the unmeasured disturbances in the system.

This also makes the dryer 202 highly resistant to unmeasured disturbances like changes in the ambient conditions, fan output, heater output, motor health, and dust and debris buildup. The system 10 is also enabled to self-learn as the feed-forward model 115 predicts what inputs will be needed in the future in order to determine errors between the predicted and measured variables when the time comes. This information is used in the machine-learning model 244 to optimize its algorithms to improve the accuracy of the feed-forward model 246. In addition, this improved model can be used both locally on the dryer under control and also by all other connected dryers using the machine-learning model 244. This is enabled by the machine-learning model 244 connection to the cloud. In practice, this allows for all dryers in a geographical area or of a certain type or for a certain grain type to learn from one another.

The condition of the grain lots 108 as they leave the dryer 202 are used for the dryeration stage 300. Depending on the drying prescription 252 the lots 108 may vary in temperature and moisture level as the lots are delivered to the dryeration stage 300. For example, the dryer 202 may maintain a higher temperature and moisture level of the lot 108 if a container in the dryeration stage 300 has a higher airflow capacity due to fan size of the low fill level. If the dryeration stage can move more air, it can finish the drying while also cooling the grain, meaning that the lot 108 can move through the dryer 202 faster. As the container in the dryeration stage 300 gets full, the airflow capacity will be reduced, and the dryer 202 would send lots 108 that were cooler and more dry.

A second dryer mechanism 202 is a counterflow with bed adjustment (CBA). The CBA 202 shares many of the features of the mixed-flow dryer but uses different methods for controlling the air quality and flow rates. With a CBA 202 grain is added to a container 255 at the top 256 and is pulled off the bottom 258. The grain 102 pulled off the bottom 258 is pulled and spread to the top 260 of the grain bed or moved to the dryeration stage 300 depending on the grains condition as indicated by sensors in the transfer augers.

Airflow within the CBA 202 is controlled by the prescriptions and information of dynamic and continuous grain depth compared to models. A control system 242 uses the same prescription or feed-forward model 115 and feedback loops 253, but with different variables. In the CBA 202 the mass flow rate of the air is controlled by adjusting the depth of the grain bed. The depth of the grain bed is increased by adding grain 102 from the wet-holding bin 104. The new grain 102 received from the wet-holding bin 104 is spread evenly across the top 260 of the grain bed to achieve a uniform grain depth. The spreader that is used can also host sensors that provide information on the grain and the air leaving the grain and also through the use fo probes protruding down the grain. The uniform spreading of the grain allows for the lots to be tracked for use in the application of the prescriptions as the grain moves down. To reduce the grain depth, grain is pulled from the bottom 258 and sent to the dryeration stage 300. Decreasing the depth of the grain bed is done through the use of sweep augers 262.

In one example, the sweep auger 262 has a plurality of teeth 263 that are tilted forward of the sweep auger 262 and are imbedded in the grain to create resistance while pulling the grain toward the top of the grain bed instead of pushing the grain forward or to the sides. This continuously fluffs the grain instead of compacting the grain. There is also a relief area 265 at the top of the sweep auger 262 to allow grain to flow through.

An end shield 267 is attached to the outer end of the sweep auger 262. The end shield is configured to be self-regulating in that as the end shield starts to fill with grain it automatically encourages the sweep auger 262 to advance.

The air quality is controlled by adjusting the operation of the fans 220 and heaters 222 that feed air into the container 254. The CBA 202 has a double-pass cooling system through the use of a roof exhaust system 264 having ducts 266 with diverters that can feed air to the input side of the fans 220 and is then fed into the plenum 218. The double-pass cooling system improves the energy efficiency of the CBA 202. Air quantity is controlled by increasing or decreasing fan 220 speed.

A plurality of sensors 232 are used in the CBA 202 and include plenum sensors 234, in-grain sensors 236, exhaust sensors 238, and machine sensors 240, and include the type of sensors as previously described.

Based on the grain conditions at input the control system 24 adjusts the air conditions and flow rates throughout the CBA 202 based on the prescription or feed-forward model 246. As grain moves through the system, the control system 242 adjusts the air condition and flow rate based on information transmitted from the sensors 232 used in the CBA 202.

In one example the feed-forward model 115 predicts the grain condition at a determined time. The sensors 232 transmit information concerning the grain condition which is compared by the control system 242 to the predicted grain condition from the feed-forward model. The difference or error is then used in a feedback loop 253 and the local optimizer 254 which adjusts the feed-forward model 115 in real time. The control system 242 then makes adjustments throughout the CBA 202, such as the grain depth, to return the grain conditions back to the target at the current time and the next sample time. This provides the same advantages of real-time adjustments, high resistance to unmeasured disturbances, and self-learning of the mixed-flow dryer 202.

### 3. Dryeration, Cooling and Conditioning

By the time the grain 102 reaches the dryeration stage 300 most of the drying has occurred. The dryeration stage 300 is used to finish any drying that needs to be done and cool the grain 102. The dryeration stage 300 is needed when grain 102 exits the drying stage 200 still warm and above desired final moisture content. In the dryeration stage 300 air pushed by fans 302 into the containers 304 will cool the grain and remove the final moisture which cools the grain 102 using less energy.

The dryeration stage 300 is known in the art but problems can arise if automated control and monitoring are not available. Problems are mitigated when the control system 242 controls the grain condition at output from the main drying stage 200.

Like the wet holding bin 104 and CBA 202 the dryeration stage 300 includes a plurality of sensors 306 used to determine grain condition and grain depth. Using a control system 308, the air quality and quantity in the dryeration containers 304 are adjusted dynamically based on the condition of the grain coming into the container 304. The sensors 306 in the dryeration stage 300 are the same as those in the main drying stage 200.

The control system 308 uses data from the main drying stage 200 to estimate the grain condition that will enter the dryeration stage 300 and will begin making prescriptions 310 for the grain in order to reach a desired final temperature and moisture content. The grain condition as it enters the dryeration stage 300 is confirmed using the sensors 306.

Based on a comparison of the initial grain condition with the predicted conditions from the prescription or feed-forward model 115 of the main drying stage 200 the control system 308 adjust the air condition and flow rates in one or more containers 304. As the grain sits in each container 304, the control system 308 adjusts the air condition based on the sensors 232 within the CBA 202. Air flow rate is adjusted in stage 300 only by the amount of grain in each container. The control system 308 sends grain 102 to different containers 304. If there is a dry-holding container 312 in stage 300 the control system diverts grain there through the control of the transfer augers and diverters. Air flow rates are adjusted using fans 314.

One example of this control is the feed-forward model 316, which predicts the grain condition at a sometime and level in the container 304. The control system 308 reads the sensors 306 at that level and the difference in the predicted and measured is calculated. This error is used by the feedback loop 316 and by the local optimizer 318 to adjust the feed-forward model 316 in real-time. Adjustments are then made in stage 300 to the manipulated variables, like the plenum temperature or fan state, to bring the grain back to the target for the current and estimated next sample time. In practice, this means that in stage 300, the in-grain sensors 306 are used to ensure that drying and cooling are going as predicted.

The condition of the grain lots 108 as they sit in the containers 304 can then be monitored to ensure they stay in good condition. The data that has been appended to the grain lots 108 as they have moved through the grain system 10 are stored on the ledger. This allows for a detailed data trail to be created for the grain lots 108.

When the grain leaves the grain site, the grain is tracked, and data is transferred to the transport container or the grain buyer. This can be done in multiple ways. If there are ID tags 109 in the grain, the tags stay in the grain as it moves into the transport container. The ID readers will see that the tags have left, and the data related to those tags is transferred to the transport or the buyer. This transaction is added to the ledger 107, allowing the verification of the grain transfer and the data transfer. This ledger framework 107 can also be used to create and execute smart contracts. The buyer can create a contract on the ledger that the seller accepts. The buyer can then send a transport to pick up the grain. When the transport gets to the grain site, the smart contract on the ledger can be verified, and the grain dispensed from the grain site per the contract using the grain site controller 112. The transport then verifies the receipt of the grain, and the contract is fulfilled. A finer value for the weight of the grain loaded into the transport will be confirmed and verified on ledger 107 when the transport reaches the scale at the buyer site, resulting in a fully executed contract.

This interface will allow the grain and the data related to the grain to be bought, sold, and delivered with very little user interaction. The transport driver can use a contract code to pick up grain from a site with little to no assistance, as these codes can be entered into a screen for the grain site controller 112. Once the codes are verified, the grain site controller can direct the transport to the correct location to be loaded. The transport can also be autonomous, and the ledger 107 will allow the autonomous transport and the grain site controller to complete the smart contracts on the ledger autonomously. An autonomous transport can communicate with the grain site controller 112 over a wireless signal like LoRa or WIFI, and the contract verification codes can be transmitted. Once the codes are verified, the grain site controller 112 can direct the transport to the correct location to be loaded.

If ID tags 109 are not present, the same can be achieved with the use of digital lots 107. As the grain site controller in both iterations can have the ability to run unload augers and read the grain height, in the container to confirm the allotted grain from the contract has been unloaded. Transport fill level can also be read using the cameras connected to the grain site controller 112. The use of smart contracts on the blockchain ledger 107 will allow for more effective logistics for grain pickup and delivery while also making the data transferable and traceable.

What is claimed is:

1. A grain drying system, comprising:
a pre-drying stage having a wet holding bin that receives harvested grain;
at least one sensor disposed within the wet holding bin;
wherein the harvested grain is broken into digital lots and the at least one sensor provides a profile of the digital lots that is transmitted to a control system that builds a model used in a feedforward control loop.

2. The grain system of claim 1 wherein the control system creates a prescription for the digital lot by setting parameters.

3. The grain system of claim 2 wherein the control system creates the prescription using a machine-learning model.

4. The grain system of claim 3 wherein the harvested grain in the wet holding bin is dried with an aeration system based on the created prescription.

5. The grain drying system of claim 1 wherein the digital lots are created by dropping a radio frequency ID into the harvested grain.

6. The grain drying system of claim 1 wherein the digital lots are created by using inventory management tools from the control system.

7. The grain drying system of claim 1 further comprising a main drying stage having one or more drying mechanisms.

8. The grain drying system of claim 7 wherein the one or more drying mechanisms include a mixed-flow dryer having at least one grain column adjacent to and in communication with a plenum having a fan and a heater, and an unloading system, and a plurality of sensors positioned throughout the mixed-flow dryer, plenum, and unloading system.

9. The grain drying system of claim 8 wherein the at least one grain column is formed by an inner wall, an outer wall, and a pair of side walls with a plurality of input ducts, output ducts, and exhaust ducts arranged in vertical rows within the at least one grain column.

10. The grain drying system of claim 9 wherein a plurality of layers are created by a rectangular section in the at least one grain column adjacent the input ducts and output ducts.

11. The grain drying system of claim 10 wherein air flow from the plenum is supplied to the plurality of layers independently and continuously by selectively adjusting the area of openings of the input and output ducts.

12. The grain drying system of claim 11 wherein the area of the openings of the input and output ducts are adjusted using a flow restrictor plate positioned adjacent the air ducts that extends horizontally through the at least one grain column.

13. The grain system of claim 9 further comprising a double-pass cooling stage wherein at least one diverter plate sends cool air to the outer duct and through the at least one grain column and into the plenum.

14. The grain system of claim 13 wherein the diverted cool air flows into the plenum before or after exposure to the heater.

15. The grain system of claim 8 wherein the control system uses information from the wet holding stage to estimate conditions of the harvested grain as it enters the main drying stage to create prescriptions for the harvested grain in the main drying stage.

16. The grain system of claim 9 wherein the control system adjusts air conditions and flow rates throughout the man drying stage based on information transmitted from the plurality of sensors positioned throughout the mixed-flow dryer, plenum and unload system.

17. The grain system of claim 7 wherein the dryer mechanism is a counterflow with a bed adjustment having a container where harvested grain is pulled off the bottom of the container and spread evenly across the top of the grain bed using a spreader having a plurality of sensors that transmit information about the harvested grain to the control system

18. The grain system of claim 17 wherein a sweep auger having a plurality of teeth tilted forward of the sweep auger are imbedded in the harvested grain to pull the harvested grain toward the top of the grain bed, and an end shield attached to the outer end of the seep auger.

19. A grain drying system, comprising:
a dryeration stage having a plurality of fans and containers that receive harvested grain from a main drying stage;
a plurality of sensors positioned in the containers;
wherein the plurality of fans push air into the containers and the plurality of sensors transmit information to a control system that adjusts air quality and quantity pushed into the containers.

20. The grain drying system of claim 19 wherein the control system uses data from the main drying stage to estimate a condition of the harvested grain when received in the containers and creates prescriptions for the harvested grain in order to reach a desired final temperature and moisture content.

21. The grain drying system of claim 20 wherein the control system adjusts air condition and flow rates in one or more containers based on predicted conditions from a prescription of the main drying stage.
